(19) United States
(12) Patent Application Publication
(10) Pub. No.: US 2005/0288136 A1
(43) Pub. Date: Dec. 29, 2005

(54) Fixed pulley assembly with start-up clutch and torque sensing device

(75) Inventor: Elmar Lorenz, Hugelsheim (DE)

Correspondence Address: ALFRED J MANGELS, 4729 CORNELL ROAD, CINCINNATI, OH, 452412433, US

(73) Assignee: LuK Lamellen und Kupplungsbau Beteilingungs KG, Buhl (DE)

(21) Appl. No.: 11/165,776

(22) Filed: Jun. 25, 2005

(30) Foreign Application Priority Data
Jun. 25, 2004 (DE) 10 2004 030 738.5

(51) Int. Cl. F16H 55/56

(52) U.S. Cl. 474/8

(57) ABSTRACT

A fixed pulley assembly for a belt-driven conical-pulley transmission contains a fixed pulley rigidly connected to an input shaft, a drive shaft, a friction clutch having an input element connected in a rotationally fixed manner to the drive shaft, an output element that can be brought into frictional engagement with the input element, and a torque sensing device operating between the output element and the fixed pulley, having a spreading surface that is rigidly connected to the fixed pulley and a sensing element that moves axially relative to the fixed pulley. The output element of the friction clutch is positioned on the side of the fixed pulley facing away from the conical surface and rotatably mounted coaxially to the input shaft. The sensing element is guided on an outer circumferential surface of the output element so that it is axially movable and is immovable in the circumferential direction.

### BACKGROUND OF THE INVENTION

1. Field of the Invention

The invention relates to a fixed pulley assembly with a start-up clutch and a torque-sensing device for use in a belt-driven conical-pulley transmission.

2. Description of the Related Art

Belt-driven conical-pulley transmissions have the advantage over automated manual shift transmissions, or automatic transmissions that operate with planetary gear sets, in that they permit the transmission ratio to be varied steplessly. This results not only in comfort advantages, but, when the belt-driven conical-pulley transmission is appropriately designed, also in fuel consumption advantages.

It is known to provide a torque sensing device between a drive shaft driven by a drive engine, for example a reciprocating piston internal combustion engine, and an input shaft of a belt-driven conical-pulley transmission that is rigidly connected to a fixed half of a V-pulley. The torque-sensing device detects the torque transmitted by the belt-driven conical-pulley transmission and sets a contact pressure for the conical disks of two conical disk pairs between which an endless, torque-transmitting means circulates in a frictional connection. Such a torque sensing device is known from, for example, DE 199 394 35 A1 or also DE 195 454 92 A1. It is also known to provide a hydraulic torque converter as a start-up clutch that drives a pinion mounted on the input shaft of the belt-driven transmission, which forms the input of the torque sensing device, whose output is non-rotatably connected to the drive shaft or the fixed disk. A rotation reversal stage can be provided between the torque converter and the drive pinion for reverse travel (WO 03/059676).

The object of the invention is to create a belt-driven conical-pulley transmission that is of compact construction, that includes a friction clutch as the start-up clutch for forward travel, and that can easily have a device added for reverse travel.

### SUMMARY OF THE INVENTION

The object of the invention is achieved with a fixed pulley assembly having a start-up clutch and torque sensing device for use in a belt-driven conical-pulley transmission which contains: a fixed pulley that is rigidly connected to an input shaft of a belt-driven conical-pulley transmission and having a conical surface for frictional engagement with a endless torque-transmitting means; a drive shaft; a friction clutch with an input element which is non-rotatably connected to the drive shaft; and an output element that can be brought into frictional engagement with the input element. A torque sensing device operates between the output element and the fixed pulley and has a spreading surface that is rigidly connected to the fixed pulley and a sensing element that moves axially relative to the fixed pulley, whose axial position determines a pressure controlled by the torque sensing device. The output element of the friction clutch is positioned on the side of the fixed pulley facing away from the conical surface and rotatably mounted coaxially to the input shaft, and the sensing element is guided on an outer circumferential surface of the output element so that it is axially movable and is immovable in the circumferential direction.

Advantageously, on the side of the friction clutch facing away from the fixed pulley there is a reversing friction clutch whose input element is engaged with the output element of the friction clutch through a gear train so as to reverse the direction of rotation, and may be brought into frictional engagement with a stationary housing of the reversing friction clutch.

The input element of the reversing friction clutch is preferably axially adjacent to the torque-sensing device and is non-rotatably connected to a ring gear of the transmission, which is in the form of a planetary transmission.

Also advantageous is a design of the fixed pulley assembly such that the housing of the reversing friction clutch has a cylindrical extension located radially outside of the torque sensing device, facing toward the fixed pulley, which may be brought into frictional engagement with the input element of the reversing friction clutch.

The friction clutches and the transmission are advantageously cooled by means of coolant supplied though the clutch housing.

When an actuating piston of the reversing friction clutch is supported against a stop element through a disk spring, the stop element is advantageously designed as a guide element that conducts coolant that has been fed in radially within the stop element to the transmission.

Alternatively, or in addition, an actuating piston of the reversing friction clutch may be connected with a guide element which, when the reversing friction clutch is open, blocks a passage to the frictional engagement of the reversing friction clutch for coolant supplied radially within the guide element, and feeds the coolant to the transmission.

An advantageous embodiment of the fixed pulley assembly according to the present invention is further distinguished by the fact that between the output element of the friction clutch and a circumferential rim of a ring component, which is rigidly connected to the fixed pulley and forms part of the torque sensing device, and which is located on the side of the output element facing away from the fixed pulley, there is a bearing arrangement that supports forces which are applied by an actuating device of the friction clutch to the output element, and which are directed axially away from the fixed pulley.

An axially parallel circumferential surface of an actuating piston of the friction clutch, which is directed radially outward, is able to form a guiding and sealing surface for a piston of the torque-sensing device.

Advantageously, the drive shaft and the input shaft are located coaxially adjacent to each other, the drive shaft is supported on bearings in the housing of the reversing friction clutch, and an extension of the input shaft is mounted in a recess of the drive shaft. Also preferred is a design of the fixed pulley such that in an annular gap between the torque sensing device and the reversing friction clutch that leads radially outward, there is a compensating part that reduces the passage cross section of the annular gap as the rotational speed increases.

### BRIEF DESCRIPTION OF THE DRAWINGS

The invention, which may be used for essentially all types of belt-driven conical-pulley transmissions, will be described below on the basis of schematic drawings in exemplary form and with additional details. In the drawings:

FIG. 1 shows an axial half section though a first embodiment of a fixed pulley assembly according to the present invention; and

FIG. 2 shows an axial half section though a second embodiment of a fixed pulley assembly according to the present invention.

### DESCRIPTION OF THE PREFERRED EMBODIMENTS

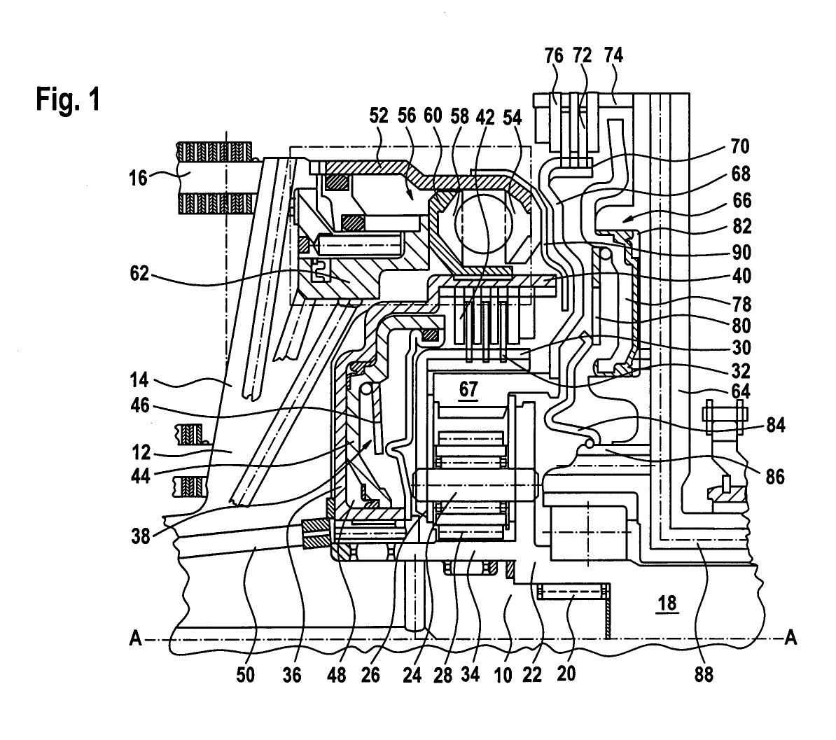

According to FIG. 1, a belt-driven conical-pulley transmission, of which only a half section of a fixed pulley assembly is shown in FIG. 1, has an input shaft 10 which is made in a single unit with a fixed pulley 12. The fixed pulley 12 has a conical surface 14 on its inner side, around which an endless torque-transmitting means 16 runs in a frictional connection. The distance between the endless torque-transmitting means and the rotational axis A-A depends on the distance between the free pulley, not shown, which moves axially relative to input shaft 10 and fixed pulley 12.

Positioned coaxially to input shaft 10 is a drive shaft 18, which has a recess, between which and an axial extension of input shaft 10 a bearing 20 is positioned.

Drive shaft 18 has an annular extension 22, to which a housing 26 of a planetary transmission which is designated in the aggregate as 28 is attached by means of bearing bolts 24.

The left half of housing 26 according to FIG. 1 forms the input element of a forward clutch, which will be described later, and ends radially on the outside in a cylindrical extension 30, to which clutch disks 32 provided with rotationally fixed friction linings are connected.

A gear 34 of planetary transmission 28 which is mounted on input shaft 10 is connected in a rotationally fixed manner to a clutch cage 36 of the forward clutch which is designated in the aggregate as 38, and which is adjacent to the back side of fixed pulley 12 and is also mounted on input shaft 10, which extends over two cylindrical intermediate regions and ends in a radial outer cylinder region 40, to which pressure disks 42 are attached in a rotationally fixed manner and with limited axial mobility, similar to disks 32.

Forward clutch 38 also has an actuating piston 44 that moves axially in clutch cage 36 and is tightly guided, which is movable to the right according to FIG. 1 against the force of a disk spring 46, in order to bring pressure disks 42 into frictional engagement with clutch disks 32.

To move actuating piston 44, a pressure chamber 48 formed between clutch cage 36 and actuating piston 44 is subjected to pressure from hydraulic fluid through a conduit 50 formed in the fixed pulley.

A cylindrical ring 52 whose free end is curved upward and on its inside forms first spreading surfaces 54 of a torque sensor designated in the aggregate as 56, is welded to the back of fixed pulley 12 at its outer circumference.

Second spreading surfaces 58, which lie opposite first spreading surfaces 54, are formed on a sensing element 60, which is engaged in a rotationally fixed manner through axial dovetailing with the circumferential surface of cylindrical region 40, but can slide axially relative to cylindrical region 40. Located between the spreading surfaces 54 and 58 are spreading parts, for example balls. Spreading surfaces 54 and 58 are formed in a known manner in such a way that when there is a relative rotation between spreading surfaces 54 and 58 around axis A-A the distance between the spreading surfaces changes. That causes sensing element 60 to shift in an axial direction, and shifts a torque sensing piston designated in the aggregate as 62, which controls hydraulic fluid passages in a known manner and is therefore not described in detail, in such a way that in torque pressure chambers of the belt-driven conical-pulley transmission a pressure that is dependent on the transmitted torque prevails. This pressure, which is dependent on the transmitted torque, can in addition be dependent in a known manner on the particular transmission ratio of the transmission. The construction and functions of torque sensor 56 are known, and are therefore not explained.

On the side of forward clutch 38 facing away from fixed pulley 12, a housing 64 of a reverse clutch, designated as a unit as 66, is mounted on drive shaft 18. Housing 64 is stationary.

Rigidly attached to a ring gear 67 of planetary transmission 38 is an annular disk 68 which extends radially on the whole, and which ends in a cylindrical extension 70. Similar to the way the cylindrical extension 30 of the housing of planetary transmission 28 forms the input element of forward clutch 38, annular disk 68 and cylindrical extension 70 form the input element of reverse clutch 66. To that end, clutch disks 72 provided with rotationally fixed frictional linings, which are positioned between pressure disks 76 that are attached in a rotationally fixed manner to a cylindrical extension 74 of housing 64, are attached to cylindrical extension 70.

Actuation of the reverse clutch 66 is accomplished by an actuating piston 78, which is movable to the left against the force of a disk spring 80 according to FIG. 1, when a pressure chamber 82 formed between actuating piston 78 and housing 64 is pressurized. Disk spring 80 is in contact with a guide plate 84, which is supported radially to the inside on a projection 86 of the housing and radially to the outside forms an abutment for disk spring 80.

Through a hydraulic conduit 88 formed in housing 64, hydraulic fluid is introduced beneath guide plate 84 into the space between the clutches, in which planetary transmission 28 is also located. In addition, pressure chamber 82 is pressurized by this hydraulic fluid.

The function of the described arrangement is as follows:

During forward travel pressure chamber 82 is depressurized, i.e., the reverse clutch is disengaged.

Pressure chamber 48 of forward clutch 38 is pressurized, so that the forward clutch is engaged with the help of actuating piston 44, and a rotationally fixed connection between drive shaft 18 and cylindrical region 40 exists, produced by frictional connection. The rotation is transmitted to sensing element 60, and from there via the spreading elements to cylindrical ring 52 and thus to fixed pulley 12. The axial position of sensing element 60 of torque sensor 56 changes, depending on the transmitted torque.

During reverse travel, pressure chamber 48 is depressurized and pressure chamber 82 is pressurized, so that the reverse clutch closes and ring gear 67 comes to a stop. That causes the rotation of drive shaft 18 to be transmitted to clutch cage 36 in the opposite direction of rotation, so that fixed pulley 12 turns in the opposite direction.

As can be seen, in its region adjacent to housing extension 86, guide plate 84 is shaped in such a way that it conducts the hydraulic fluid or coolant, which is fed in radially within the guide plate, into the inside of the ring gear and further to the forward clutch.

Overall, with the described design of the assembly the following significant advantages are achieved:

The friction clutches, which run entirely in hydraulic oil or coolant, work largely without wear and are precisely controllable. The arrangement of the torque sensor, laterally alongside and within the reverse clutch and radially outside of the forward clutch, and the nested arrangement of the planetary transmission, which operates as a reversing gearbox within the forward clutch, makes an extraordinarily compact design possible. The distance between the middle range of conical surface 14 of fixed pulley 12 and the right outer side of housing 64 according to FIG. 1 can be less than 100 mm. The arrangement of sensing element 60 on the outer side of clutch cage 36 permits a simple dovetailing geometry, which combines high functional reliability with low costs.

To compensate for the force of escaping oil, or so that at high rotational speeds only a limited amount of cooling oil flows away outward radially, an additional plate 90 may be attached to the outer side of cylindrical ring 60, which changes shape as the rotational speed increases, in such a way that a passage cross section between cylinder ring 52 and ring wheel 68 becomes smaller.

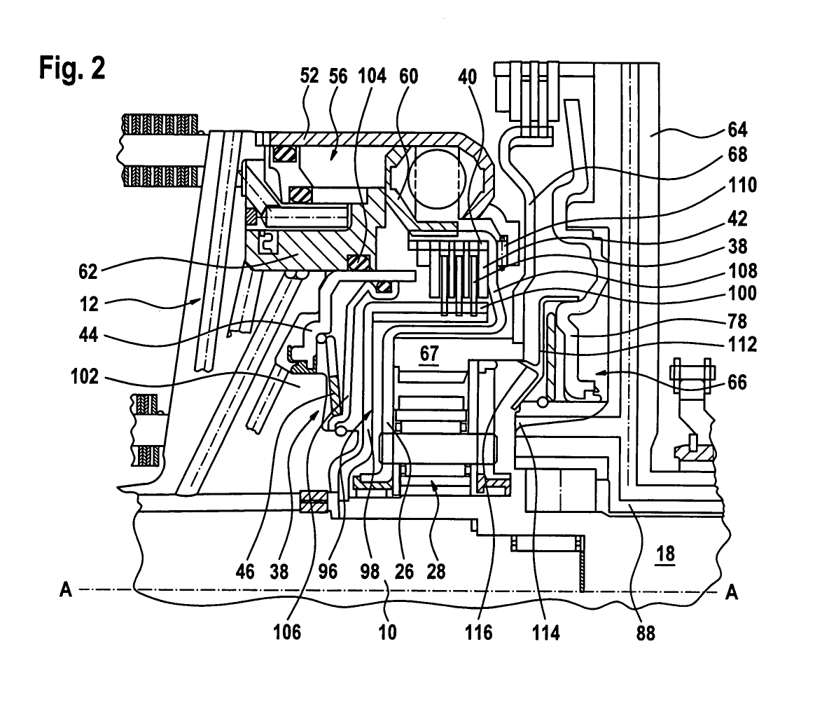

Another exemplary embodiment of a fixed pulley assembly according to the present invention is described below on the basis of FIG. 2, with not all parts having reference numerals assigned for the sake of clarity, but above all those that are essential to explaining the differences between the two assemblies.

In the exemplary embodiment according to FIG. 2, drive shaft 18 is rigidly connected to a ring flange 98 that forms the input element of forward transmission 38, which ring flange ends in a cylindrical region 100 to which clutch disks 32 are attached in a rotationally fixed manner. Actuating piston 44 of the forward clutch is guided closely along a projection 102 of fixed pulley 12 on the one hand, and on the other hand by means of a seal 104, directly along disk sensing piston 62, forming a seal. Disk spring 46, for forcing actuating piston 44 into its position which disengages the clutch, is supported against actuating piston 44 and a stop ring part 106, which is positioned between the fixed pulley and a cylindrical extension of actuating piston 44.

Pressure disks 42 of forward clutch 38 are not positioned on a clutch cage 36, as in the case of the embodiment according to FIG. 1, but rather on an extension of housing 26 of planetary transmission 28, which according to FIG. 2 is first curved to the right to a cylindrical region, then continues radially in a ring extension and curves off to the left to a cylindrical region 40, which carries the pressure disks 42 and with which sensing element 60 is engaged.

Between the ring region 108 of the housing extension, which runs radially outward, and a radially running end region of the cylinder ring 52, which is rigidly connected to the fixed pulley, is an axial thrust bearing, for example in the form of a needle bearing, which supports actuating forces that are exerted by actuating piston 44.

An additional difference from the embodiment according to FIG. 1 consists in a guide ring 112, preferably made of plastic, which is attached to actuating piston 78 of the reverse clutch and is supported on a projection of housing 64 above the inlet opening for cooling fluid. Guide ring 112 has a ring projection 116, which is shaped in such a way that in the illustrated disengaged position of reverse clutch 66 it makes contact substantially with an inner ring surface of the projection of ring gear 67, so that the passageway for fluid to the frictional engagement of the reverse clutch 66 is closed and all of the cooling fluid is fed to the planetary transmission 28 or to the frictional engagement of the forward clutch.

With the advanced design of the fixed pulley assembly the following significant additional advantages are achieved compared to FIG. 1:

In order to be able to position the torque sensor piston 62 as far to the inside radially as possible, actuating piston 44 of forward clutch 38 seals directly against torque piston 62. The support of the axial force via the axial thrust bearing 110 when the forward clutch is engaged causes this axial force to be introduced directly into the very rigidly designed cylinder ring 52, which relieves the force on other components. At high rotational speeds the cylinder ring 52 bends upward somewhat, so that the passage between cylinder ring 52 and annular disk 68, which leads radially outward, can serve to compensate for escaping oil forces.

It should be pointed out that features of the two illustrated embodiments can be combined with each other in various ways. With both embodiments, which can be modified in many ways, the nested arrangement of forward clutch, torque sensor, reverse clutch and reversing transmission directly on the back side of the fixed pulley, makes it possible to achieve an extraordinarily compact design of the fixed pulley assembly.

Although particular embodiments of the present invention have been illustrated and described, it will be apparent to those skilled in the art that changes and modifications can be made without departing from the spirit of the present invention. Accordingly, it is intended to encompass within the appended claims all such changes and modifications that fall with the scope of the present invention.

1. A fixed pulley assembly with start-up clutch and torque sensing device for use in a belt-driven conical-pulley transmission, said assembly comprising:
a fixed pulley that is rigidly connected to an input shaft of a belt-driven conical-pulley transmission and having a conical surface for frictional engagement with an endless torque-transmitting means;
a drive shaft;
a forward friction clutch with an input element that is connected in a rotationally fixed manner to the drive shaft;
an output element frictionally engageable with the input element;
a torque sensing device operative between the output element and the fixed pulley and including a spreading surface that is rigidly connected to the fixed pulley, and a sensing element that moves axially relative to the fixed pulley and whose axial position determines a pressure controlled by the torque sensing device;
wherein the output element of the forward friction clutch is positioned on a side of the fixed pulley facing away from the conical surface and is rotatably mounted coaxially to the input shaft, and wherein the sensing element is guided on an outer circumferential surface of the output element so that it is axially movable and is immovable circumferentially.

2. A fixed pulley assembly in accordance with claim 1, wherein on a side of the forward friction clutch facing away from the fixed pulley there is positioned a reversing friction clutch having an input element engaged with the output element of the forward friction clutch through a planetary transmission to reverse the direction of rotation of the output element, and which may be brought into frictional engagement with a stationary housing of the reversing friction clutch.

3. A fixed pulley assembly in accordance with claim 2, wherein the input element of the reversing friction clutch is axially adjacent to the torque sensing device and is connected in a rotationally fixed manner to a ring gear of the planetary transmission.

4. A fixed pulley assembly in accordance with claim 2, wherein the reversing friction clutch includes a having a cylindrical extension located radially outside of the torque sensing device and facing toward the fixed pulley, and wherein the housing cylindrical extension is frictionally engageable with the input element of the reversing friction clutch.

5. A fixed pulley assembly in accordance with claim 4, wherein cooling of the forward and reversing friction clutches and of the transmission takes place by means of coolant which is conducted through the clutch housing.

6. A fixed pulley assembly in accordance with claim 5, wherein an actuating piston of the reversing friction clutch is supported through a disk spring against a stop element which is formed as a guide element to supply to the transmission coolant that has been fed in radially within the stop element.

7. A fixed pulley assembly in accordance with claim 5, wherein an actuating piston of the reversing friction clutch is connectable with a guide element which, when the reversing friction clutch is disengaged, blocks a passage to the frictional engagement of the reversing friction clutch for coolant supplied radially within the guide element, and conducts the coolant to the transmission.

8. A fixed pulley assembly in accordance with claim 1, wherein between the output element of the forward friction clutch and a circumferential rim of a ring component that is rigidly connected to the fixed pulley and forms part of the torque sensing device, and which is located on a side of the output element facing away from the fixed pulley, there is positioned a bearing arrangement that supports forces which are applied to the output element by an actuating device of the forward friction clutch, which forces are directed axially away from the fixed pulley.

9. A fixed pulley assembly in accordance with claim 1, wherein an axially parallel circumferential surface of an actuating piston of the forward friction clutch, which is directed radially outward, forms a guiding and sealing surface for a piston of the torque sensing device.

10. A fixed pulley assembly in accordance with claim 2, wherein the drive shaft and the input shaft are located coaxially adjacent to each other, the drive shaft is supported on bearings in a housing of the reversing friction clutch, and an extension of the input shaft is mounted in a recess of the drive shaft.

11. A fixed pulley assembly in accordance with claim 5, wherein at an annular gap between the torque sensing device and the reversing friction clutch, which gap leads radially outward, there is a compensating part that makes a cross section of the annular gap smaller as the rotational speed increases.
